(19) United States
(12) Patent Application Publication
(10) Pub. No.: US 2012/0148334 A1
(43) Pub. Date: Jun. 14, 2012

(54) Locker Binder Kit Arrangement and System

(76) Inventor: Adam Merzon, Greenwich, CT (US)

(21) Appl. No.: 13/225,394

(22) Filed: Sep. 2, 2011

Related U.S. Application Data
(60) Provisional application No. 61/380,129, filed on Sep. 3, 2010.

(51) Int. Cl. B42F 13/40; B42F 13/16

(52) U.S. Cl. 402/4; 402/70

(57) ABSTRACT

The present invention provides in combination a binder locker arrangement having; a case comprised of a pair of binder locker covers pivotable about a spine into an opposed orientation; each of the pair of binder locker covers attached to the spine such that the binder locker covers may close into an opposed orientation, further including at least one set of binder rings, a plurality of binders adapted to be received into the binder locker a plurality of accessory hold down pages adapted to be received into the binder locker.

### CROSS-REFERENCE TO RELATED APPLICATIONS

This application claims the benefit of U.S. provisional patent application Ser. No. 61/380,129 filed Sep. 3, 2010, the entire contents of which are incorporated herein by reference.

### FIELD OF THE INVENTION

The present invention relates to binders, and more specifically to a set of one or more binders and accessories that may be used in conjunction with a locker binder.

### BACKGROUND OF THE INVENTION

In the past, binder arrangements consisted of a single binder having a pair of covers each joined to a spine by a hinge with at least one binder, such as a three ring binder, attached to an inside surface of one of the covers, wherein each of the binders may be used to accommodate loose leaf paper, folder files and other accessories such as tabbed subject separators and pencil cases for example. However, a problem may sometimes exist with the use of conventional binder arrangements in that typically, they may accommodate materials for only one or two particular subject matters. This leads to the need to maintain multiple binders for various subjects.

In addition, once a binder arrangement is set up with the materials needed for a particular subject or task, it is difficult to customize that binder without a lengthy period of time needed for organization and re-stocking to be used for another subject or purpose. However, a user may encounter additional problems when removing items from a past binder arrangement. Once items are removed from past binder arrangements those items may no longer securely organized and connected as they are within the binder. This can result in the materials becoming lost, damaged, or unorganized.

Moreover, in order to stay organized, a user may typically need multiple binder arrangements, with each binder arrangement prepared for a different use. This can be both cumbersome and time consuming as the user must spend time and energy stocking several binder arrangements with a complete array of paper, folders, pencil cases and other accessories needed for each used. The user must therefore duplicate the purchase of several items if they wish to have each binder arrangement completely outfitted with the necessary resources, equipment and related accessories. In order to avoid redundant purchases, some users of past binder arrangements may resort to using one or two larger binder arrangements which can accommodate materials for multiple subjects. This can result in the user needing to carry a binder that is larger than needed.

Furthermore, in binder arrangements of the past, it can be difficult for a user to access and remove materials quickly and efficiently when needed since it is difficult in past binder arrangements to segregate materials while also ensuring that the materials are securely fastened within the binder arrangement.

Past binder arrangements often include a hold down cover whose function is to help hold down the contents being held by the binder to keep the contents of the binder more organized. Unfortunately, hold down pages typically are themselves not tied down or otherwise anchored, making them largely ineffective. In addition, hold down pages often warp, curl or become bent over time because of this. As a result, hold down pages are often a nuisance and many times are discarded. Additionally, the hold down covers of past binder arrangements typically provide no additional functionality and provide little benefit to the user.

Binder arrangements can be packaged in the configuration of a case that can be opened using a zipper that has one end attached to the spine. Unfortunately, over time, repeated openings and closings of the zipper can tear the end of the zipper from the spine or tear the zipper such that the zipper teeth will no longer properly engage thereby making it difficult, if not impossible, to close the case.

Finally, binder arrangements that have a pair of opposed binders often are difficult to close because the rings of one of the binders often interferes against the rings of the other one of the binders. Repeated interference can cause binder rings to bend making it difficult to open and close them. Just as bad, interference between the rings can cause creasing of one or both covers if excessive force is applied, such as what can happen out of frustration, when closing the binder arrangement.

What is needed is an improved binder arrangement that can be configured as a locker for holding one or more smaller 3-ring binders that addresses at least one of these problems. What is further needed is a binder arrangement that can be quickly and easily user customizable in accordance with the users needs.

### SUMMARY OF THE INVENTION

The invention is directed to an integrated binder arrangement that can be configured with 3 distinct components. The integrated binder arrangement may include: a locker binder for holding at least one three-ring binder and or accessory in a single customizable east to use and portable unit; a three-ring binder, which is the basic organizational unit and may incorporate a plurality of features and be of various sizes; and a plurality of accessory designs.

The inner surface of one or both covers of the locker binder can be equipped with a binder that has a plurality of rings capable of opening to receive sheets of material or a three ring binder or accessory and closing to retain the sheets of material or a three ring binder or accessory.

In one embodiment, the binder arrangement includes a board or panel of one piece, unitary and homogenous construction from which the covers and spine are formed. The board or panel includes hinges each of which is located between one of the covers and the spine such that the binder locker covers may be pivoted into an opposed orientation.

Each locker binder may be equipped in one embodiment with a single set of binder rings and in alternate embodiments with a pair of binder rings. In an alternate embodiment wherein the binder locker arrangement may be equipped with a pair of generally opposed binder rings, the rings may be offset such that one of the binders does not directly overlie the other one of the binders during closing thereby preventing binder ring clashing. In one embodiment of the binder locker having a pair of generally opposed binders, one binder is offset relative to the other binder in a lateral direction. In another embodiment of the binder locker having a pair of generally opposed binders, one binder is offset relative to the other binder in a longitudinal direction, such that one binder is spaced farther away from a centerline of the spine than the other binder.

Each binder can be equipped with an accessory hold down sheet that has an adjustable latch arrangement that is self-adjusting to accommodate varying binder storage volumes. The latch arrangement includes a latch strap that preferably is of flexible construction that engages with a latch receiver. One of the latch strap and latch receiver has a hook strip of a hook and loop fastener arrangement and the other one of the latch strap and latch receiver has a loop strip of a hook and loop fastener arrangement. The latch strap preferably is anchored to one of the binder covers and the latch receiver preferably comprises either a hook strip or a loop strip that is fixed directly to the hold down page.

The accessory hold down sheets may be of various designs to permit and enhance the users ability to organize and access the contents of the locker binder. The various accessory designs may include for example a tab-file, a folder file, a pencil case and a clipboard.

In one preferred embodiment, the binder arrangement is configured as a case that has sidewalls extending about the outer edges of the binder covers that are releasably joined by a fastening arrangement that permits skirts of the sidewalls to be separated to enable the binder arrangement to be opened or closed. The fastening arrangement preferably is attached to the spine by a stretchable gather that preferably is of elastomeric construction.

The case preferably is formed of an outer covering that is fixed to the binder covers and spine that terminates in sidewall skirts that extend outwardly beyond the peripheral edges of the binder covers. A preferred fastening arrangement is a zipper that has one end anchored to the spine by gather such that the gather stretches as needed when the zipper is being opened or closed to reduce tension at the zipper end.

Objects, features and advantages of the invention include an integrated binder arrangement that can be configured with 3 distinct components. The integrated binder arrangement may include: a locker binder for holding at least one three-ring binder and/or a plurality of accessories which may be of various designs to permit and enhance the users ability to organize and access the contents of the locker binder in a single customizable easy to use and portable unit. The three-ring binder, which is the basic organizational unit and may incorporate a plurality of features and be of various sizes; and a plurality of accessory designs; the locker binder may incorporate a single three-ring binder or a plurality of generally opposed binders that prevents, if not eliminates, binder ring clashing by offsetting one of the binders relative to the other one of the binders in either a longitudinal or lateral direction; a binder arrangement that is configured as a case that has a zipper end mounted to the binder arrangement by a resilient and elastomeric shock absorbing arrangement that stretches as needed to take up, transfer and absorb stresses transmitted through the zipper during case opening and closing; a binder arrangement equipped with a hold down page latch arrangement that is positively locking and that is adjustable; and a binder arrangement that is of economical construction, that is robust, that is reliable, that is long-lasting, that is more durable, that is of simple construction, and which is economical to make and use.

The present invention is a system and method that meets the needs set forth above, more particularly, the present invention provides. In combination a binder locker arrangement having; a case comprised of a pair of binder locker covers pivotable about a spine into an opposed orientation; each of the pair of binder locker covers attached to the spine such that the binder locker covers may close into an opposed orientation, further including at least one set of binder rings, a plurality of binders adapted to be received into the binder locker. a plurality of accessory hold down pages adapted to be received into the binder locker.

### BRIEF DESCRIPTION OF THE DRAWINGS

The drawings illustrate the best mode currently contemplated of practicing the present invention.

In the drawings:

FIG. 1 is a perspective view of a binder arrangement in a closed position constructed according to the present invention;

FIG. 2 is a perspective view of a binder arrangement in an open position constructed according to the present invention;

FIG. 3 is a perspective view of a binder arrangement in an open position constructed according to the present invention;

FIG. 4 is a perspective view of the binder arrangement of FIG. 1 in an open position;

FIG. 5 is a perspective view of the opened binder arrangement showing binder rings and internal binders and accessories.

FIG. 6 is a top plan diagram of a particular embodiment of the binder arrangement of the present invention;

FIG. 7 is a top plan diagram of various embodiments of the binder arrangement of the present invention;

FIG. 8 is a top plan diagram of various embodiments of the binder arrangement of the present invention;

FIG. 9 is a perspective view of one embodiment of the binder arrangement and binder rings according to the present invention.

FIG. 10 is a side view diagram of a particular embodiment of the binder arrangement of the present invention;

FIG. 11 is a side view diagram of a particular embodiment of the binder arrangement of the present invention;

FIG. 12 is a perspective view of the opened binder arrangement showing binder rings and internal binders and accessories.

FIG. 13 is a perspective view of the opened binder arrangement showing binder rings and internal binders and accessories.

FIG. 14 is a perspective view of the opened binder arrangement showing binder rings and internal binders and accessories.

FIG. 15 is a top plan view diagram with of the opened binder arrangement showing elastomeric gather zipper anchor;

FIG. 16 is a perspective view of a three-ring binder which may be received by the binder arrangement according to the present invention;

FIG. 17 is a perspective view of an alternate three-ring binder which may be received by the binder arrangement according to the present invention;

FIG. 18 is a top plan view of an accessory hold down which may be received by the binder arrangement according to the present invention;

FIG. 19 is a top plan view of an alternate accessory hold down which may be received by the binder arrangement according to the present invention;

FIG. 20 is a top plan view of a further alternate accessory hold down which may be received by the binder arrangement according to the present invention;

FIG. 21 is a top plan view of a further alternate accessory hold down which may be received by the binder arrangement according to the present invention;

FIG. 22 is a perspective view of a latch strap feature according to the present invention.

### DETAILED DESCRIPTION

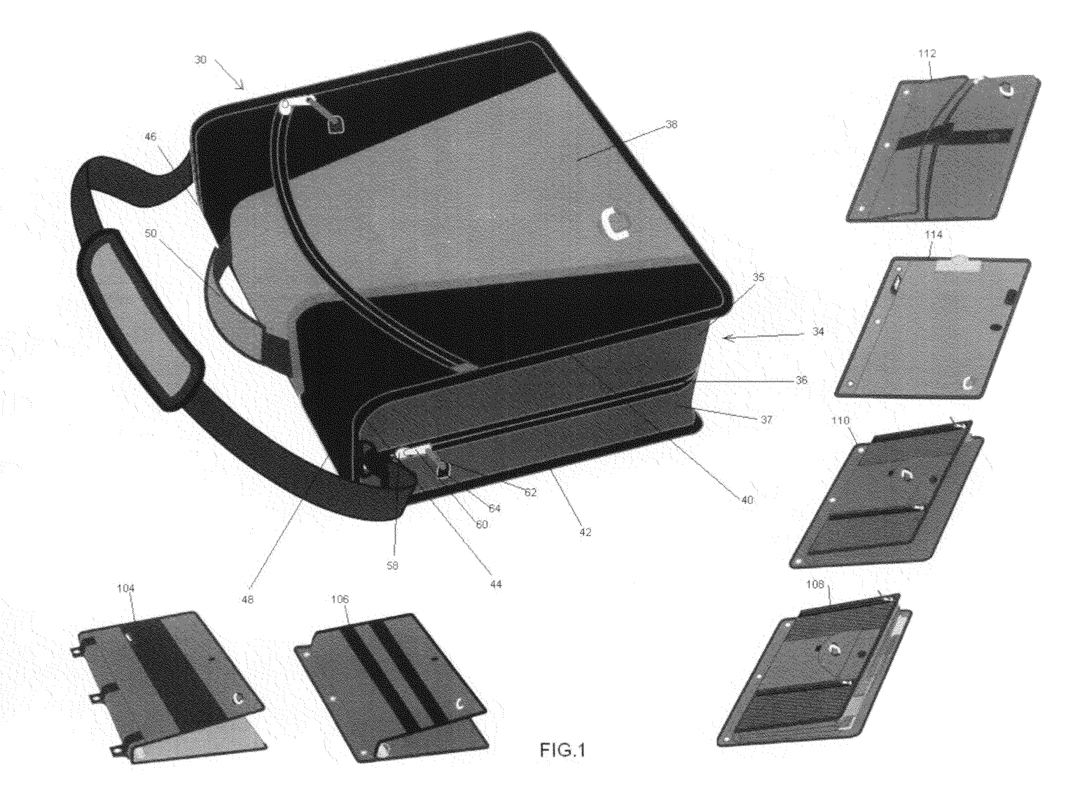

FIG. 1 illustrates an embodiment of a locker binder arrangement 100 of the present invention. The particular embodiment depicted includes a locker binder 30, at least one 3 ring binder 104 and 106; and a plurality of accessories 108-114.

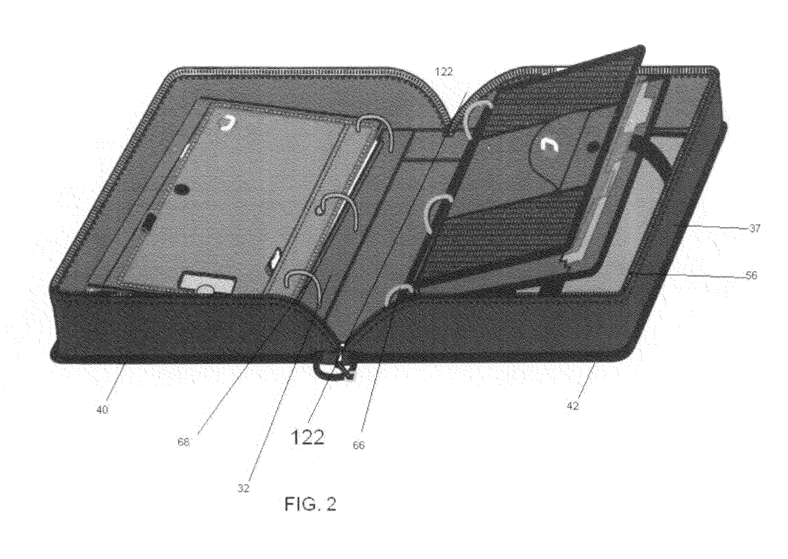

The locker binder 30 of the invention includes at least one binder 66 (as depicted in FIG. 2) and flexible fabric sidewalls 34 that retain the binder arrangement 30 in a closed position via a fastening arrangement 36. When disposed in the closed position with the fastening arrangement engaged, such as is shown in FIG. 1, the locker binder arrangement 30 preferably forms a case 38 that houses and protects the binder contents.

The binder arrangement 30 has a front cover 40 that overlies a rear cover 42 with the front and rear covers each respectively joined by a hinge 44, 46 to a spine 48 that carries a handle 50. As is seen in FIG. 1-3, each sidewall 34 is interrupted by and releasably joined together by a fastening arrangement 36 that preferably is a zipper 56 dividing the sidewall 34 into an upper skirt 35 and lower skirt 37. To facilitate opening and closing, a slide 58 of the zipper 56 has a zipper pull tab 60 to which a lanyard 62 is attached. The lanyard 62 preferably includes a handle 64 at its free end that a user can conveniently grasp.

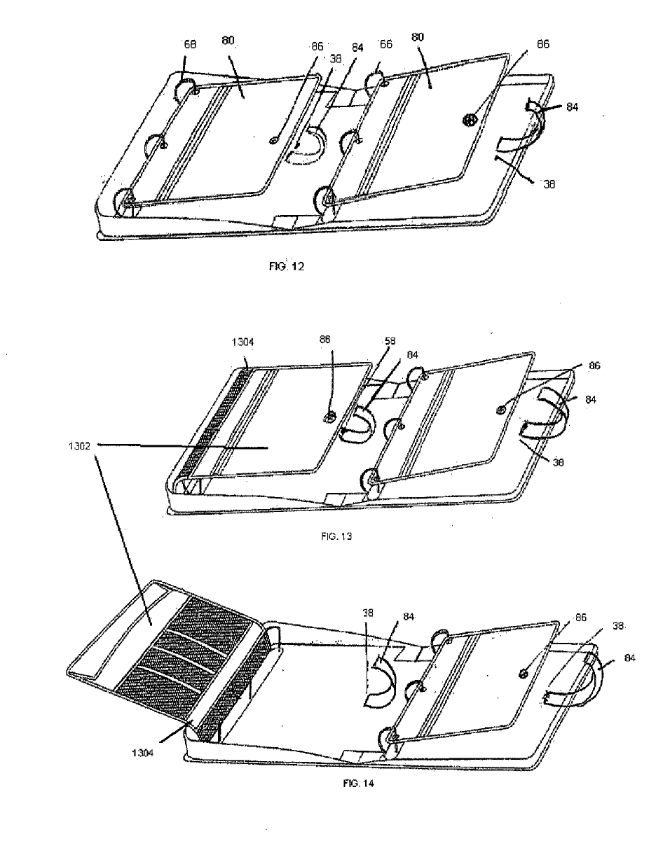

The locker binder 30 is advantageously adapted to receive at least one 3 ring binder 104 and 106, and a plurality of accessories 108-114. As will be further shown and described in FIGS. 13-17, the present invention may include alternate embodiments of a 3 ring binder which is adapted to be received within locker binder 30.

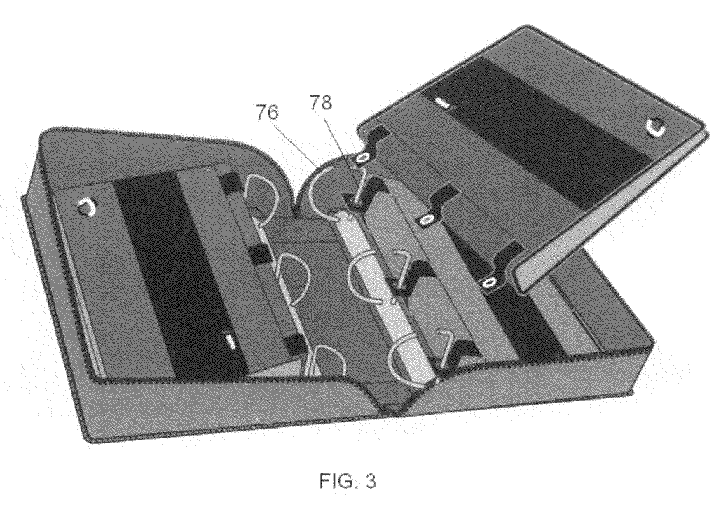

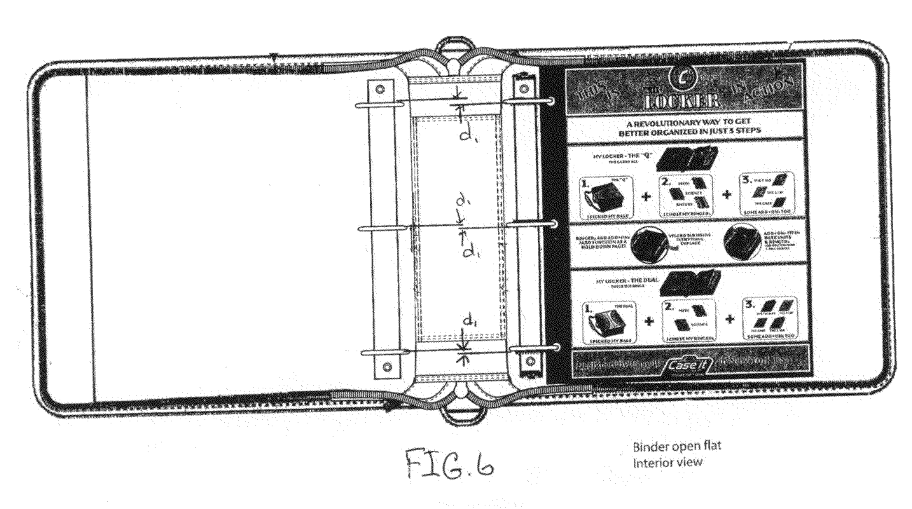

FIGS. 2 and 3 shows the locker binder case 38 in an opened position. In the particular embodiment depicted in FIG. 2, the case 38 may have a plurality of opposed binders, each of which preferably is a three ring binder 66 and 68. Each binder 32 has a mounting post and may be permanently attached to one of the covers by a plurality of spaced apart fasteners such as a rivet. Each binder ring 66 and 68, as can be more clearly seen in FIG. 3, may have a pairs of separable ring halves 76, 78 used to releasably retain pages of material. As will be further described with respect to FIG. 9, binder rings 66 may be alternately shaped to advantageously retain materials within binder case 38. In the embodiment depicted in FIGS. 2-3, the binder rings 68 mounted on cover 40 are spaced an equal distance from a centerline 122 of the spine 48 than the binder 66, which is mounted on the other cover 42. In FIG. 7 the binder rings 68 mounted on cover 40 are spaced farther away longitudinally from a centerline 122 of the spine 48 than the binder 66, which is mounted on the other cover 42. Such a longitudinal offset advantageously facilitates closing the binder arrangement 30 without the binders 66 and 68 interfering with each other or closure of the locker binder arrangement 30. Therefore, as shown in FIGS. 2-3 and FIG. 6-8, the binders 66 and 68 may be spaced apart on either side of spine 48, the width of which preferably is selected to permit the case 38 to be closed without the binders 66 and 68 interfering with case closure or each other.

A further alternate embodiment is shown and described in further detail herein with respect to FIG. 9. FIG. 9 depicts a locker binder case 38 may also have a single three ring binder 66. Furthermore, the three ring binder 66 of the case 38 having a single set of binder rings may be configured in a plurality of alternate geometric shapes in order to more advantageously retain the contents of the locker binder 38.

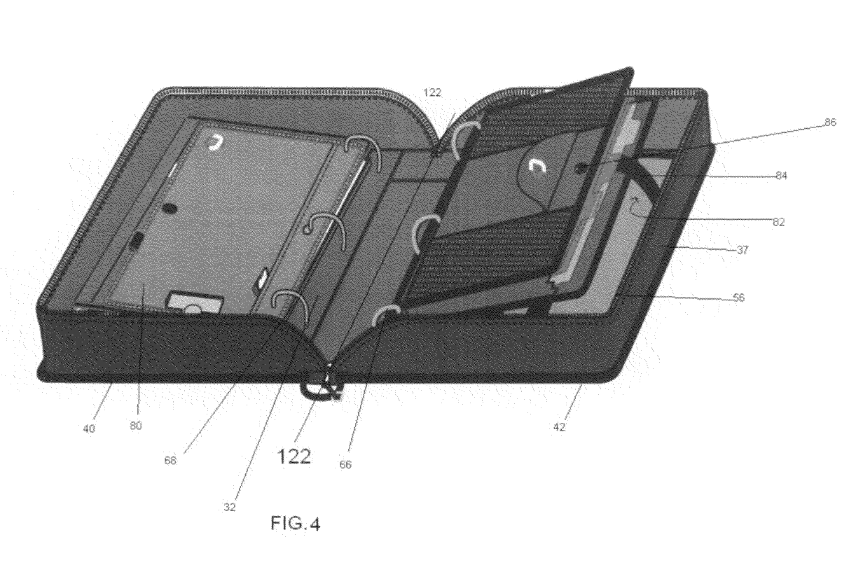

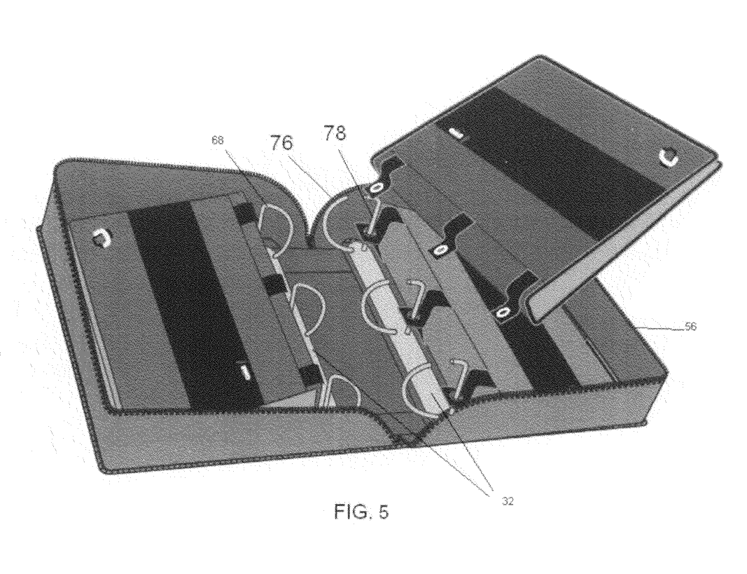

Turning now to FIGS. 4 and 5, there is shown an alternate embodiment of locker binder 30, having a dual binder ring configuration. FIGS. 4 and 5 show the locker binder case 38 in an opened position. In the particular embodiment depicted in FIGS. 4 and 5, the case 38 may have a plurality of opposed binders, each of which preferably is a three ring binder 66 and 68. Each binder 32 has a mounting post and may be permanently attached to one of the covers by a plurality of spaced apart fasteners such as a rivet. Each binder ring 66 and 68, as can be more clearly seen in FIG. 5, may have a pairs of separable ring halves 76, 78 used to releasably retain pages of material. As will be further described with respect to FIG. 9, binder rings 66 may be shaped to advantageously retain materials within binder case 38. In the embodiment depicted in FIGS. 4-5, the binder rings 66 and 68 mounted on covers 42 and 40 respectively are spaced an equal distance away longitudinally from a centerline 122 of the spine 48. However, binders 66 and 68 are offset laterally by a predetermined distance, such that the binders 66 and 68 do not directly overlie one another when the locker binder arrangement 30 is closed. Such a lateral offset advantageously facilitates closing the binder arrangement 30 without the binders 66 and 68 interfering with each other or closure of the locker binder arrangement 30. Therefore, as shown in FIGS. 4 and 5 and FIG. 6-8, the binders 66 and 68 may be spaced apart on either side of spine 48, in such a way so as to permit the case 38 to be closed without the binders 66 and 68 interfering with case closure or each other.

Furthermore, as can be seen in FIGS. 4 and 5 the straight portion of binder ring half 78 may be angled several degrees from vertical away from the centerline of the binder when the locker binder is in an open position. In this way, when the locker binder is open with binders or other accessories installed, the binders or accessories will not directly overlay each other, but instead will be slightly offset relative to each other by the angle of ring half 78. In this way, the carrying capacity of the locker binder is increased since the internal binders and accessories can be moved by the angle feature of the ring half such that their spines do not overlay when the locker binder is open, therefore minimizing the height of the internal components while the binder is open.

Each binder 66 and 68 may also include one or more accessories designs 108-114 to permit and enhance the users ability to organize and access the contents of the locker binder. Each accessory 108-114 may be releasably latched in a closed position by an adjustable latch 82 that includes an anchor strap 84 that is anchored to an interior part of the case 38 and a latch receiver 86 that is attached to the hold down page 80.

Turning now to FIGS. 6-8 there are illustrated alternate embodiments of the locker binder wherein the binders 66 and 68 may, be anchored within the locker binder cover in different locations. In one embodiment shown in FIG. 6, the rings halves 76 and 78 of the three ring binders 66 and 68 are offset laterally by a distance, d.sub.1. In one embodiment, d.sub.1 may be between one-quarter inch and three-quarters of an inch. As a result of this offset, where the binder arrangement 30 is a dual opposed binder arrangement as depicted in FIG. 6, the binders 66 and 68 do not directly overlie one another when the binder arrangement 30 is closed. Such an offset advantageously facilitates closing the binder arrangement 30 without the binders 66 and 68 interfering with each other or closure of the binder arrangement.

In an alternate embodiment depicted in FIG. 7, binders 66 of one cover 40 are spaced farther away longitudinally from a centerline 122 of the spine 48′ than the binder 68 of the other cover 42. In the embodiment shown in FIG. 7, the distance, d.sub.1, between binders 66 of cover 40 is greater than the distance, d.sub.2, between binders 68 of cover 42. As a result of this offset, where the binder arrangement 30 is a twin opposed binder arrangement, the binders 66 and 68 do not directly overlie one another when the binder arrangement 30 is closed. Such an offset advantageously facilitates closing the binder arrangement 30 without the binders 66 and 68 interfering with each other or closure of the binder arrangement.

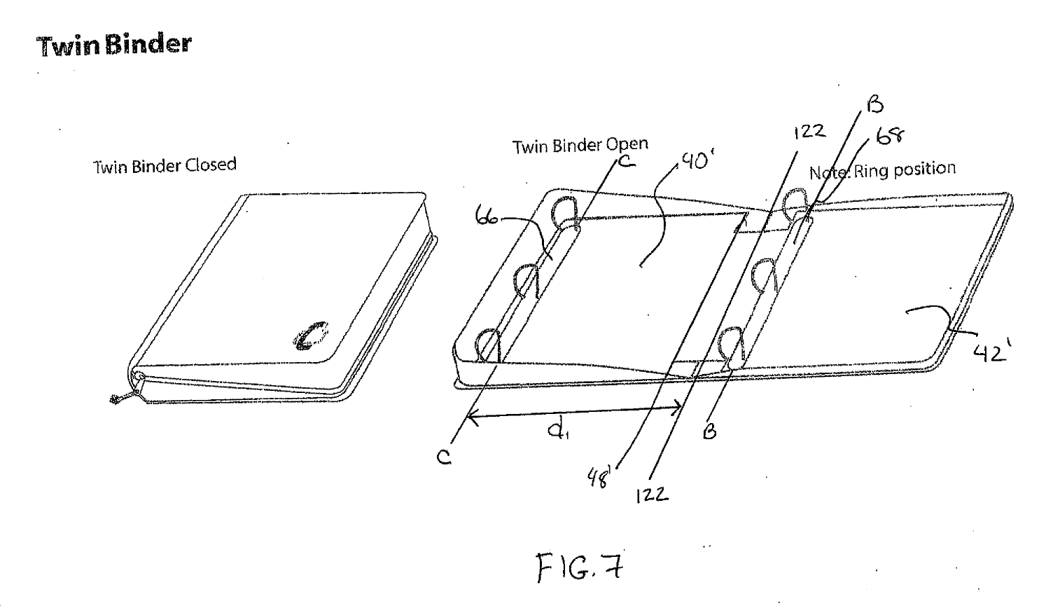

FIGS. 8 and 9, depict another alternate embodiment of the locker binder 30 having a single set of three-ring binders. As shown in FIG. 9, the binder rings halves 76 and 78 of the single binder ring embodiment shown in FIGS. 8 and 9 are specially adapted to receive at least one 3 ring binder 104 and 106; and a plurality of accessories 108-114.

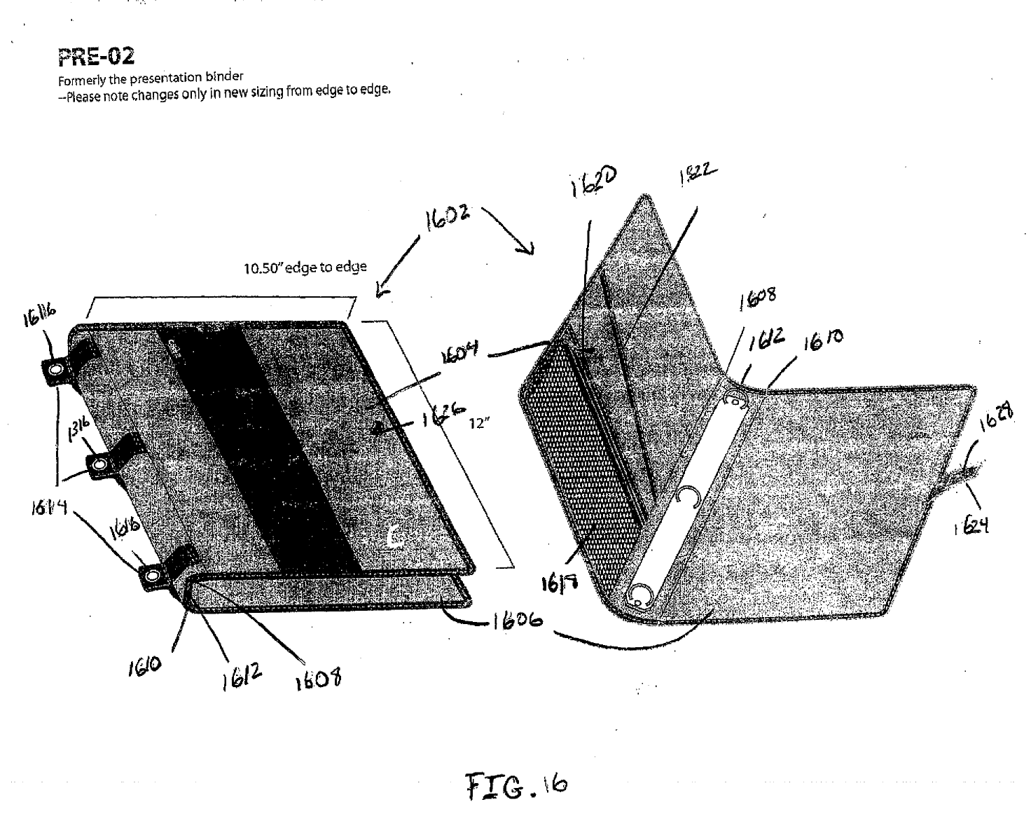

Specifically, binder ring halves 76 and 78 are rectangular in shape, and may be of various heights depending on the intended use and desired retaining capacity of the binder. For example, the rings may be between one (1) and four (4) inches in height, although this height is not meant to be limiting and serves only to describe an exemplary embodiment. As will be further shown and described with respect to FIGS. 16-21, the three ring binders 104 and 106; and accessories 108-114 include a grommet adapted to be received within binders halves 76 and 78 that may be mounted to either individual tabs extending from the spine of the three ring binder or to a flange as part that extends from the rear cover of binder. As can be seen in FIG. 9, the rectangular binder ring 66 is shaped to receive the grommets of either a three ring binder 104, 106 or accessories 108-114 to retain the binder or accessory. The rectangular ring shape and dimensions allows the binder or accessory to be advantageously retained within the locker binder 30 by providing room to stack such three ring binders 104, 106 or accessories within the locker binder 30. Moreover, the straight upright portion of ring halves 76 and 78 are designed to retain the three ring binders 104, 106, accessories 108-114 or other materials, such as three hole loose leaf paper in an orderly and organized manner. This is accomplished by the straight upright portion or ring halves 76 and 78 retaining the edge of the binder, accessory or material that is adjacent the binder ring 66 along a single plane. This allows the locker binder 30 to maintain a uniform arrangement of its contents, which allows the locker binder to close easily while retaining its contents.

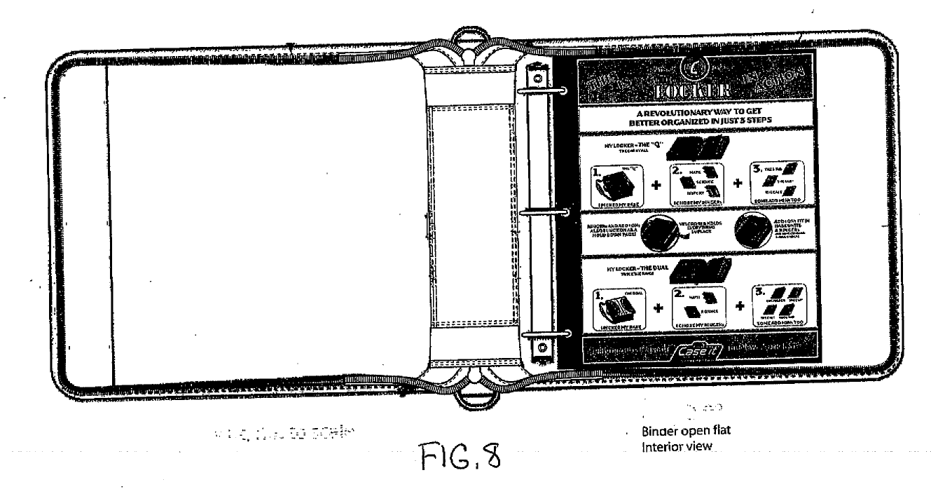

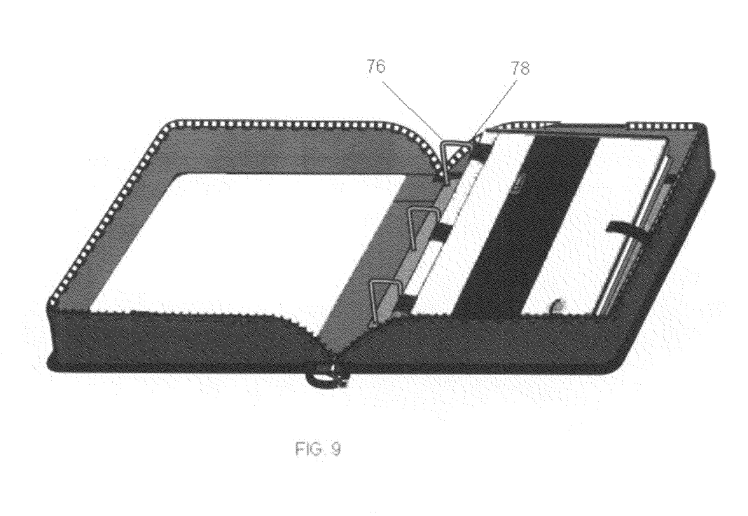

Turning now to FIGS. 10 and 11, there is shown a bottom end view of the locker binder 30 depicted in FIGS. 1-3. FIG. 10 depicts the locker binder from the bottom end view in a closed position, where binder rings 66 and 68 are in an opposed position, such that the straight edge ring half portion 78 of binders 66 and 68 are positioned towards each other. Furthermore, there is shown a hold down page 1102, which may be for example any one of the accessory items 108-114 depicted in FIGS. 1-3, and sidewall 34. As can be seen in FIG. 10, when the locker binder 30 is in a closed position, the binder rings 68 mounted on cover 40 are spaced farther away longitudinally from a centerline 122 of the spine 48 than the binder 66, which is mounted on the other cover 42. Such a longitudinal offset advantageously facilitates closing the binder arrangement 30 without the binders 66 and 68 interfering with each other or closure of the locker binder arrangement 30. Therefore, as shown in FIGS. 2-3 and FIG. 6-8, the binders 66 and 68 may be spaced apart on either side of spine 48, the width of which preferably is selected to permit the case 38 to be closed without the binders 66 and 68 interfering with case closure or each other.

Turning to FIG. 11, depicts the bottom end view of the locker binder 30 in an open position. As can be seen, in the open position, the binder rings 68 mounted on cover 40 are spaced farther away longitudinally from a centerline 122 of the spine 48 than the binder 66. Furthermore the sidewall 34 is shown as having an upper skirt 35 and lower skirt 37 which may be divided by a fastening arrangement, such as a zipper, (not seen in this view, to facilitate opening and closing of the locker binder 30.

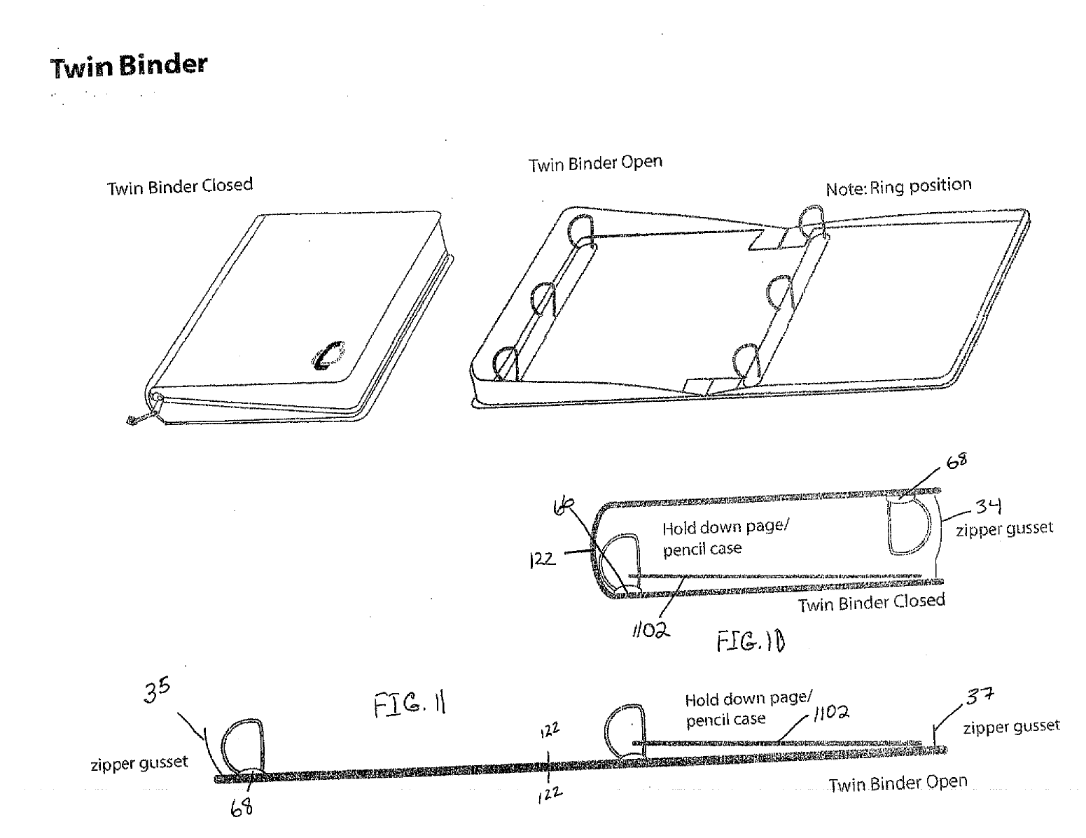

FIGS. 12-14 depict further alternate embodiments of the locker binder 30 according to the present invention. FIG. 12 shows a locker binder 30 according to the present invention which may incorporate hold down pages 80 which are releasably retained by binders 66 and 68. FIGS. 13 and 14 depict a further alternate embodiment wherein one hold down page 1302 may be incorporated and attached to locker binder case 30. In the embodiment shown in FIGS. 13 and 14, the hold down page 1302 preferably is fixed, such as by stitching or the like, to the interior of case 38. In this embodiment, the hold down page 1302 may incorporate a flexible and resilient hinge 1304. The flexible and resilient material of hinge 1304 has a width and contour that permits bending to take place to impart a radius of curvature to the bend to conform to the rings of binder 68. In that way the locker binder 30 may be easily closed without the hold down page 1302 interfering or unnecessarily adding to the bulk of the locker binder.

Also shown in FIGS. 12-14, As previously described with respect to FIG. 4, hold down pages 80 also incorporate an adjustable latch 82 that includes an anchor strap 84 that is anchored to an interior part of the case 38 and a latch receiver 86 that is attached to the hold down page 80.

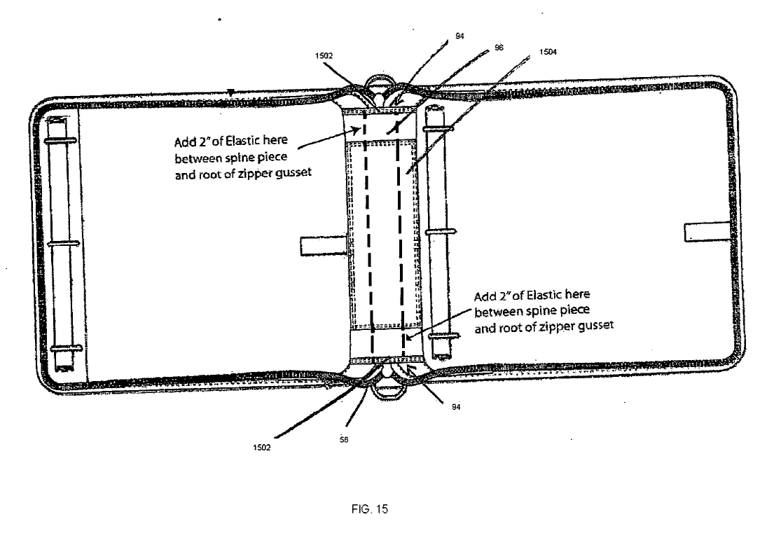

FIG. 15, illustrates a bottom stop region 94 of the zipper 56 which is movably anchored by an elastomeric gather 96 that preferably is made of an elastic band material or of an elastic rubber. The elastomeric gather 96 is fixed at both ends 1502, preferably via stitching (not shown) to fabric in the bottom stop region of the zipper 56. In the embodiment shown in FIG. 15, the elastomeric gather 96 is retained to the binder case 38 by underling an outer covering 1504 of the case 38. The elastomeric gather 96 may freely slide along under outer covering 1504 thereby flexes to enable the binder arrangement 30, when configured in case form, to be more conveniently used in an open position. In addition, the gather 96 stretches at least slightly to help accommodate opening of the case 38, while preventing the stress and strain of repeated openings and closings from tearing the zipper bottom stop region 94 from the spine 48. As such, the gather 96 acts as a shock absorber to accommodate repeated case openings and closings without tearing free of the spine 48 and without damaging or tearing any portion of the zipper 56. By allowing the elastomeric gather to freely float under outer cover 1504, stress is relieved on the zipper bottom stop region 94 and the spine since the elastomeric gather 96 is not attached to the spine and thereby prevents forces from opening the binder case or the zipper to be directly transmitted to the zipper 56, the spine 48 or the flexible sidewalls 56.

FIG. 16 illustrates a three-ring binder 1602, which has a has a front cover 1604 that overlies a rear cover 1606 with the front and rear covers each respectively joined by a hinge 1608, 1610 to a spine 1612. The spine 1612 carries on its outside surface three gusset tabs 1614 of flexible material or fabric, that are fixed to the hinge at one end, preferably via stitching, and are aligned to be received by the rings 66 or 68 (FIGS. 1-3) of locker binder 30. Each of the gusset tabs 1614 include a reinforcing grommet 1616 which may be used to releasably retain the three-ring binder 1602 within a locker binder 30, by being grasped by ring halves 76 and 78 (FIGS. 1-3). There is also incorporated a latch 1624 and receiver 1626 for maintaining the three-ring binder in a closed position. The latch 1624 and receiver 1626, as is shown in FIG. 16 with the latch 1624 disposed in an unlatched position, the latch 1624 may be comprised of a fabric strap to which a loop strip 1628 is attached, and the latch receiver 1628 is a hook strip that is attached to the cover 1604. While a hook and loop fastener tape that is adhesively applied can be used, the loop strip preferably is fixed, such as by stitching or the like, to the latch strap 1624, and the hook strip preferably is fixed, such as by stitching or the like, to the cover 1604. Furthermore, the latch receiver 1628 may also be attached to latch 84, (not shown in this view) for retaining the binder 1602 in a closed position, and in order to secure the three ring binder 1602 within locker binder 30, thereby using three ring binder 1602 as a hold down device within the locker binder 30.

Three ring binder 1602 may also include an interior pocket or case 1618, which may be made of a mesh material, and may include a zipper 1620 or other closure mechanism.

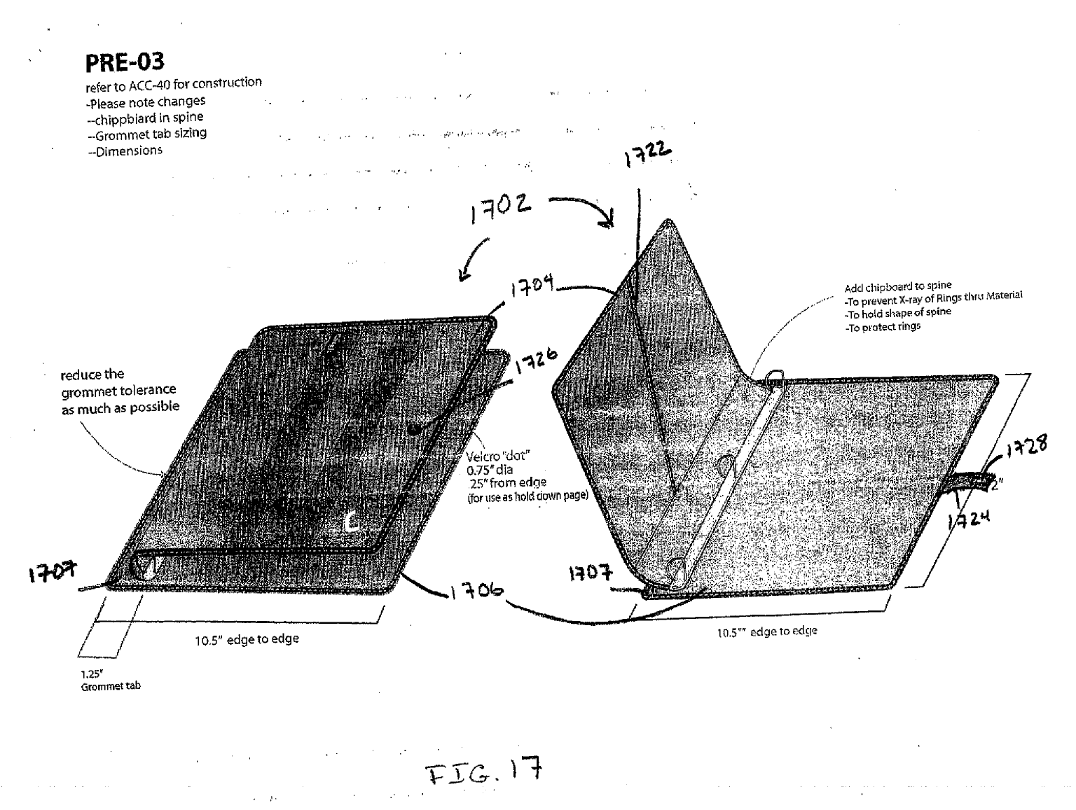

FIG. 17 illustrates a three-ring binder 1702, which has a has a front cover 1704 that overlies a rear cover 1706 with the front and rear covers each respectively joined by a hinge 1708, 1710 to a spine 1712. The rear cover 1706 has a flange part 1707 that extends from the rear cover of binder 1702. The flange 1707 includes reinforcing grommets (not seen in this view) which are arranged to be in alignment with the rings of binder 66 (FIGS. 1-3) and may be used to releasably retain the three-ring binder 1702 within a locker binder 30, by being grasped by ring halves 76 and 78 (FIGS. 1-3). There is also incorporated a latch 1724 and receiver 1726 for maintaining the three-ring binder in a closed position. The latch 1724 and receiver 1726, as is shown in FIG. 17 with the latch 1724 disposed in an unlatched position, the latch 1724 may be comprised of a fabric strap to which a loop strip 1728 is attached, and the latch receiver 1728 is a hook strip that is attached to the cover 1704. While a hook and loop fastener tape that is adhesively applied can be used, the loop strip preferably is fixed, such as by stitching or the like, to the latch strap 1724, and the hook strip preferably is fixed, such as by stitching or the like, to the cover 1704. Furthermore, the latch receiver 1728 may also be attached to latch 84, (not shown in this view) for retaining the binder 1702 in a closed position, and in order to secure the three ring binder 1702 within locker binder 30, thereby using three ring binder 1702 as a hold down device within the locker binder 30.

Three ring binder 1702 may also include an interior 1722 incorporated within the scope of this invention as would be contemplated by one skilled in the art.

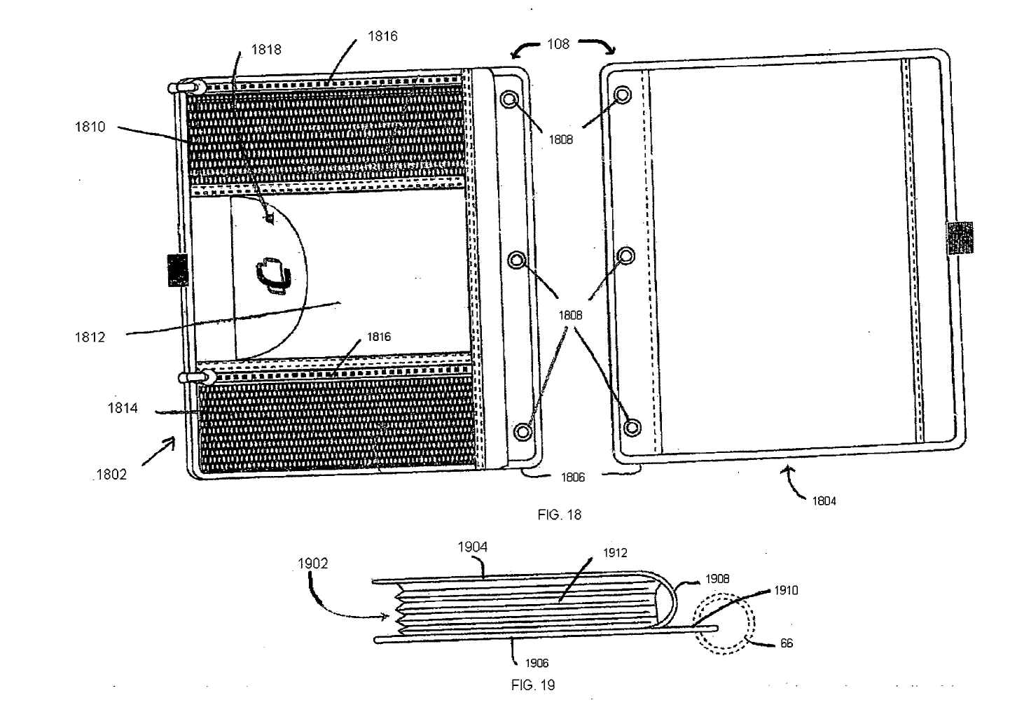

FIG. 18 illustrates one alternate embodiment of an accessory hold down page 108, 110, which includes a folder pocket, (not shown in this view) which may contain a 5 tab file. In the alternate embodiment depicted, hold down page 80 showing a front view 1802 and a back view 1804. The hold down page 108, 110 includes an extended flange part 1806. The flange 1806 includes reinforcing grommets 1808 which are arranged to be in alignment with the rings of binder 66 (FIGS. 1-3) and may be used to releasably retain the hold down page 108, 110 within a locker binder 30, by being grasped by ring halves 76 and 78 (FIGS. 1-3).

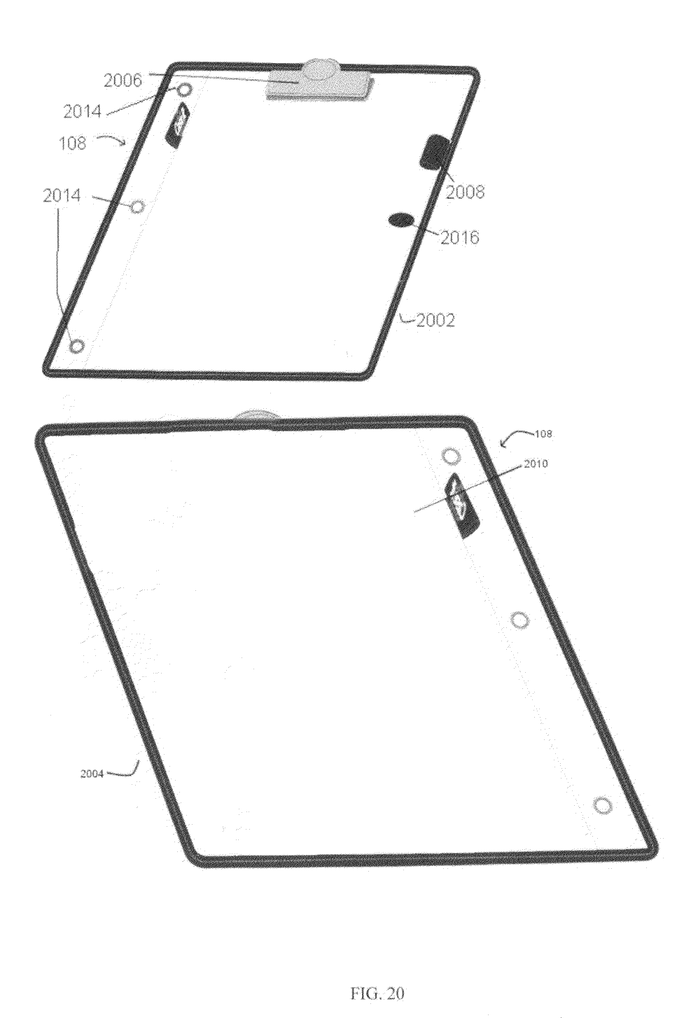

At least the outer surface of the hold down page 108, 110 is equipped with a plurality of article holders. In the preferred hold down page embodiment depicted in FIGS. 16 and 20, the outer surface and the hold down surface 238 both preferably include a plurality of article holders, each of which preferably is configured to hold a different type of article. The front side may include three separate compartments 1810, 1812 and 1814. The compartments may be formed of a mesh material such as in the case of compartments 1810 and 1814 and may be closed by means of a fastening arrangement 1816, typically a zipper. As will be further described herein, the mesh material may be a elastic or expandable material, which enables the pocket to be stretched to a larger volume to accommodate larger or a greater number or items. The material may be a resilient material so that it returns to its original size and shape after items are removed so that it does not interfere with closing the locker binder. The compartment 1812 may also be constructed of a nylon material with a flap 1818 to close and secure the compartment. The flap may be held closed with a hook and loop fastener device, a snap or button on the underside of the flap (not shown). The compartment may be expandable to accommodate over-size items by way of pleated side walls (not shown) which may be unfolded to expand the compartment when larger items are placed within the compartment.

Turning now to FIG. 19 there is shown a side view of the hold down page shown in FIG. 18. From the side view there is shown a folder pocket 1902 which has a has a front cover 1904 that overlies a rear cover 1906 with the front and rear covers each respectively joined by a flexible spine 1908. The rear cover 1906 has a flange part 1910 that extends from the rear cover 1906. The flange 1910 includes reinforcing grommets (not seen in this view) which are arranged to be in alignment with the rings of binder 66 (FIGS. 1-3) and may be used to releasably retain the three-ring binder 1702 within a locker binder 30, by being grasped by ring halves 76 and 78 (FIGS. 1-3). There is also incorporated a flexible pleated sidewall 1912 for folder pocket 1902. The compartment may be expandable to accommodate over-size items by way of pleated side walls which may be unfolded to expand the compartment to increase the volume within the folder pocket. In one particular embodiment the folder pocket 1902 may be simply used to contain objects such as books, reports, and loose leaf paper. In another embodiment, folder pocket 1902 may include an internal index file compartment. The index file compartment may be contained within the expandable pleated side walls 1912 and adapted to receive papers of usual size, typically 8½ by 11, although one skilled in the art could make modifications to folder pocket 1902 to receive papers of alternate sizes. The index file compartment may be divided into a number of separate expandable file sections, each with an individual index tab divider wherein any number of index tabs and file sections may be provided.

Turning now to FIG. 20, there is shown another alternate embodiment of a hold down page. The hold down page depicted has a front side 2002 and a back side 2004. The front side of the hold down page 114 shown in FIG. 20 may also include a retaining clip 2006 for releasably holding loose paper or other objects onto the hold down page. The retaining clip 2006 may be biased to the closed position by a spring or other resilient elastic device. In this way the clip may be opened to insert items such as paper and then may return to its closed position to hold item on hold down page 114. In the embodiment depicted in FIG. 20, the hold down page may be constructed of a rigid material with a smooth surface on front side 2002, to make it suitable for serving as a writing surface. Hold down page 114 may also include an elastic material loop 2008 for retaining a writing implement such as a pen, pencil, marker or crayon. The back side 2004, may include a pocket 2010 for retaining loose leaf paper or other such thin items. The hold down page 114 has a flange part 2012 that extends along the side of the hold down page. The flange 2012 includes reinforcing grommets 2014 which are arranged to be in alignment with the rings of binder 66 (FIGS. 1-3) and may be used to releasably retain the hold down page 114 within a locker binder 30, by being grasped by ring halves 76 and 78 (FIGS. 1-3). The hold down page 108 further includes a fastener dot 2016 which may be part of a hook and loop fastener used to releasably retain the hold down page. The fastener dot 2016 may be attached to a latch strap 84 (FIGS. 4, 12-14) As is shown in more detail in FIG. 22 with the latch 82 disposed in an unlatched position, the strap 84 is a fabric strap to which a loop strip 88 is attached, and the latch receiver 2016 is a hook strip that is attached to the hold down page 108. The hook strip 2016 preferably is fixed, such as by stitching or the like, to the hold down page 114.

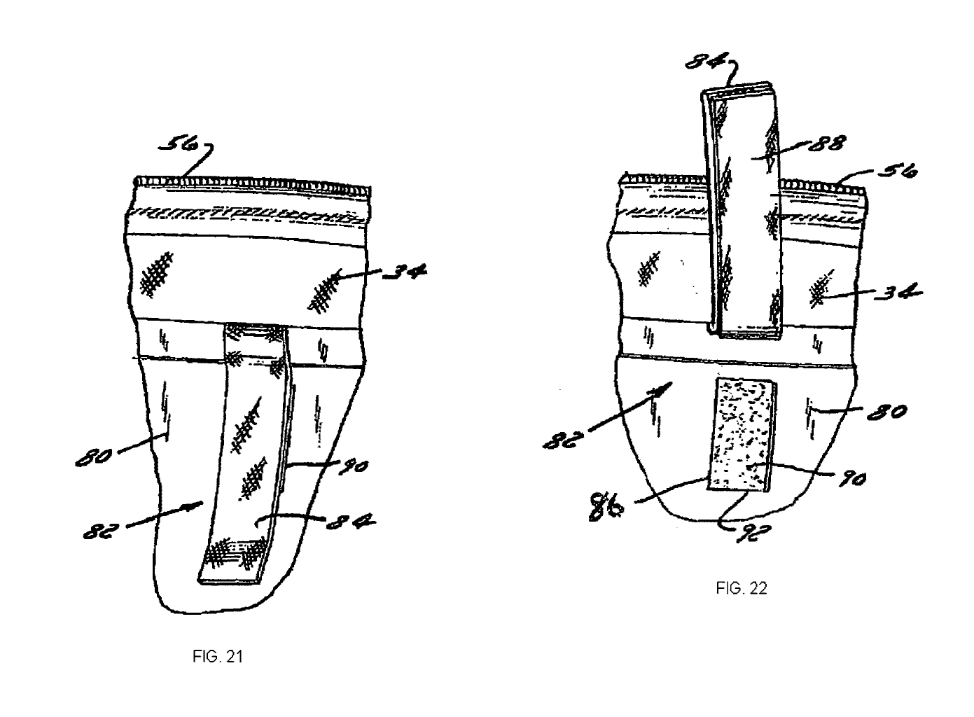

Turning now to FIG. 21, there is shown another alternate embodiment of a hold down page. The hold down page depicted may advantageously be used as a pencil case for retaining small articles such as pencils, erasers, and other small supplies. The compartment 2100 may also be constructed of a nylon material with a flap 2102 to close and secure the compartment. The flap may be held closed with a hook and loop fastener device, a snap or button on the underside of the flap (not shown). The compartment may be expandable to accommodate over-size items by way of pleated side walls (not shown) which may be unfolded to expand the compartment when larger items are placed within the compartment.

FIG. 22 depicts a latch strap for retaining a hold down page in a closed position. In an embodiment shown in the drawing figures, the strap 84 and latch receiver 86 are comprised of a hook and loop fastener arrangement. As is shown in more detail in FIG. 22 with the latch 82 disposed in an unlatched position, the strap 84 is a fabric strap to which a loop strip 88 is attached, and the latch receiver 86 is a hook strip 90 that is attached to the hold down page 80. While a hook and loop fastener tape that is adhesively applied can be used, the loop strip 88 preferably is fixed, such as by stitching or the like, to the latch strap 84, and the hook strip 90 preferably is fixed, such as by stitching or the like, to the hold down page 80.

The length of each strip 88 and 90 is selected so as to ensure positive engagement there between for a wide variety of binder thicknesses. For example, in one preferred embodiment, the loop strip 88 extends at least one inch beyond an end 92 of the hook strip 90 and preferably extends as much as two inches beyond the hook strip end 92 when the associated binder is empty. Additionally, the loop strip 88 is at least one and one-half times the length of the hook strip 90 to help ensure maximum engagement between the two strips 88 and 90.

Alternate pockets, holders and hold down pages described with respect to FIGS. 16-20 may be incorporated within the scope of this invention as would be contemplated by one skilled in the art and are not limited by the embodiments described herein. Types and construction of various hold down page embodiments which may be included in the present invention are shown in U.S. Pat. No. 7,661,900 by Merzon, issued Feb. 16, 2010, and U.S. patent application Ser. No. 10/858,280, which application is hereby incorporated by reference in its entirety.

In use, a locker binder arrangement 30 of the invention is well suited for holding articles that include paper, media, photos, as well as other things. In a preferred embodiment, such as that shown in drawing FIGS. 1-20, the binder arrangement 30 is configured as a case 38 that preferably includes flexible sidewalls 34 releasably joined by a fastening arrangement 36. If desired, the binder arrangement 30 can be configured so it is not a case such that it lacks sidewalls 34 and fastening arrangement 36.

In operation, where the binder arrangement 30 is configured as a case 38, the case 38 can be closed such as in the manner shown in FIG. 1. When the case 38 is disposed in a closed position, the case 38 can be grasped by its handle 50 and conveniently carried like a suitcase. If desired, a detachable shoulder strap (not shown) can be attached to the strap loops 52 and 54, enabling the case 38 to be carried like a shoulder bag or the like.

The locker binder arrangement 30 of the invention is further particularly adapted to serve as an integrated binder system arrangement that can be configured with 3 distinct components. The integrated binder arrangement may include: a locker binder for holding at least one three-ring binder and/or a plurality of accessories which may be of various designs to permit and enhance the users ability to organize and access the contents of the locker binder in a single customizable easy to use and portable unit.

Referring to FIG. 1-3, the case 38 can be opened by grasping the zipper lanyard 62 and pulling the zipper slide 58 in a direction away from one end of the spine 48 of the binder arrangement 30. To fully open the case 38, the zipper slide 58 is pulled in a direction that causes each pair of opposed zipper teeth of the zipper 56 to disengage. The zipper slide 58 is pulled in this manner about the periphery of the case 38 until it stops adjacent the other end of the spine 48.

The case 38 is opened by grasping both covers 40 and 42 and pulling one away from the other until both covers 40 and 42 and the spine 48 are aligned in the manner depicted in FIG. 4. When the case 38 is nearly completely open, the sidewalls 34 of the case 38 that lie along the side of the case 38 where the zipper slide 58 resides become taught, thereby creating tension at the joint created where the zipper teeth meet in the zipper bottom stop region 94. This tension is at least partially dissipated or relieved by the stretchable gather 96 used to anchor the zipper bottom stop region 94 to the spine 48. As a result, the tension actually present where the zipper teeth meet in the zipper bottom stop region 94 is greatly reduced because at least a portion of it is transferred to and absorbed by the gather 96. By the gather 96 providing stress or tension relief in this manner, tearing in the zipper bottom stop region 94 is prevented, which thereby also prevents zipper failure. In addition, by using a stretchable gather 96 to attach the zipper bottom stop region 94 to the spine 48, it functions as a shock absorber that prevents the zipper bottom stop region 94 from tearing free of the spine 48.

To access the contents of one of the binders 66 or 68, the hold down page 80 of that binder is unlatched and the hold down pages 108-114 is pulled upwardly so it rotates on the ring halves 76 and 78 toward the spine 48. To unlatch the hold down page 80, the latch strap 84 is grasped and pulled away from the hold down page 80 until the loop strip 88 disengages from the hook strip 90. When fully disengaged, the hold down page 80 can be manipulated in the manner previously discussed to expose and permit access to the binder contents underneath.

Where the binder arrangement has two or more binders, such as binder arrangement 30 that is equipped with binders 66 and 68, any pair of binders 66 and 68 that would overlie one another when the binder arrangement is closed is offset such that the binders 66 and 68 do not directly overlie one another when the binder arrangement 30 is closed.

In a preferred embodiment, the binder arrangement 30 includes an integral case 38 that is equipped with a covering that can be, for example, ballistic nylon or the like. To help increase durability, the covering overlies both sides of each cover 40 and 42 and the spine 48. The covering preferably is attached to a board 108, such as by stitching, an adhesive, fasteners, or a combination thereof. A band is attached to the spine 48 and carries the handle 50 and both strap loops 52 and 54 while preferably reinforcing the spine 48. The band preferably is attached to the spine 48 using stitching, an adhesive, fasteners or the like.

Various alternatives are contemplated as being within the scope of the following claims particularly pointing out and distinctly claiming the subject matter regarded as the invention.

What is claimed is:

1. In combination:
a) a binder locker arrangement having;
a case comprised of a pair of binder locker covers pivotable about a spine into an opposed orientation; each of said pair of binder locker covers attached to said spine such that said binder locker covers may close into an opposed orientation, further including at least one set of binder rings;
b) a plurality of binders adapted to be received into said binder locker;
c) a plurality of accessory hold down pages adapted to be received into said binder locker.

2. The combination defined in claim 1, further comprising a first and a second sets of binder rings carried a predetermined distance from a centerline of said spine wherein said centerline is located at the midpoint between a first and a second side edge of said pair of binder covers.

3. The combination defined in claim 1, wherein said binders include a pair of covers pivotable about a spine into an opposed orientation; each of said pair of covers attached to said spine such that said binder covers may close into an opposed orientation, further including at least one set of binder rings mounted within said covers and having means for releasably retaining said binder within said locker binder.

4. The combination defined in claim 3 wherein said means for releasably retaining said binder within said locker binder includes a plurality of gusset tabs attached in a cantilever manner to the exterior of said spine.

5. The combination defined in claim 3 wherein said means for releasably retaining said binder within said locker binder includes a flange attached to the exterior of one of said covers.

6. The combination defined in claim 4, wherein each of said plurality of gusset tabs further includes a grommet adapted to be received and releasably retained within said binder locker.

7. The combination defined in claim 5, wherein each of said plurality of gusset tabs further includes a grommet adapted to be received and releasably retained within said binder locker.

8. The combination defined in claim 1, wherein at least one of said binders has a releasable latch that releasably anchors the binder to one of said locker binder covers.

9. The binder arrangement of claim 8 wherein said latch comprises a latch strap that is carried by one of the covers and the hold down page and a latch receiver that is carried by the other one of said covers and said binder.

10. The combination defined in claim 2, wherein one of the binder rings is offset from the other one of the binder rings such that the binder rings do not overlie each other when the binder locker is disposed in a closed position with one of the covers generally overlying the other one of the covers.

11. The combination defined in claim 2 wherein one of said set binder rings is offset relative to the other one of the binder rings such that one of said binder rings is spaced farther away from a centerline of said spine than the other one of said binders.

12. The combination defined in claim 1 further comprising flexible sidewalls that each comprise a top and bottom skirt that extends along the side edges of each cover of said locker binder covers wherein said top skirt is releasably attached to said bottom skirt by a fastening arrangement that is elastically attached to a stretchable gather.

13. The combination defined in claim 12 wherein said fastening arrangement comprises a zipper, and said stretchable gather is attached at one end to a bottom stop region of said zipper, and said stretchable gather is attached at or adjacent its other end to a top stop region of said zipper.

14. The combination defined in claim 13 wherein the said stretchable gather is slidably retained within said binder locker covers by a flexible overlay.

15. The combination defined in claim 14, wherein said flexible overlay is a smooth fabric.

16. The combination defined in claim 1 wherein said plurality of accessory hold down pages include a hold down surface and an outer surface opposite the hold down surface, and further comprising an article holder carried by the multifunction hold down page and disposed on the outer surface of the multifunction hold down page.

17. The combination defined in claim 16 wherein the article holder is integrally formed of the accessory hold down page.

18. The combination defined in claim 16 wherein the article holder comprises a pocket for releasably holding an article therein.

19. The combination defined in claim 16 wherein the pocket is integrally formed of the multifunction hold down page.

20. The combination defined in claim 16 wherein the article holder comprises a notebook or notepad holder.

21. The combination defined in claim 20 wherein the notebook or notepad holder comprises a clipboard.

22. The combination defined in claim 16 wherein the article holder comprises a mesh pocket.

23. The combination defined in claim 16 wherein the article holder comprises an integrally formed folder.

24. The combination defined in claim 23 wherein said folder comprises a tab file arrangement.

25. The combination defined in claim 16 wherein the article holder comprises a pen or pencil holder.

26. The combination defined in claim 16 wherein the article holder comprises a card holder.

27. The combination defined in claim 2 wherein each of said binder rings includes a plurality of fastening mechanisms, said binders are fixed substantially hermaphroditical with respect to each other, and each said fastening mechanism on said binder rings is provided in a staggered position with relation to the opposite said fastening mechanism such that said fastening mechanism do not overlie each other when the binder locker arrangement is disposed in said closed position.

28. The binder arrangement according to claim 27, wherein said fastening mechanism includes a linear structure and a curved structure such that the linear structure is not in a vertical position when the binder locker arrangement is in an open position.

29. A binders comprising a pair of covers pivotable about a spine into an opposed orientation; each of said pair of covers attached to said spine such that said binder covers may close into an opposed orientation, further including at least one set of binder rings mounted within said covers and having means for releasably retaining said binder within a three ring binder.

30. The binder of claim 29 wherein said means for releasably retaining said binder within said three ring binder includes a plurality of gusset tabs attached in a cantilever manner to the exterior of said spine.

31. The binder of claim 30, wherein each of said plurality of gusset tabs further includes a grommet adapted to be received and releasably retained within said three ring binder.

32. The binder of claim 29 wherein said means for releasably retaining said binder within said three ring binder includes a flange attached to the exterior of one of said covers.

33. The binder of claim 32, wherein each of said flange further includes a plurality of grommets adapted to be received and releasably retained within said three ring binder.
